(19) United States
(12) Patent Application Publication
(10) Pub. No.: US 2021/0091611 A1
(43) Pub. Date: Mar. 25, 2021

(54) MULTI-PART STATOR, ELECTRIC MACHINE AND METHOD FOR PRODUCING A MULTI-PART STATOR AND AN ELECTRIC MACHINE

(71) Applicant: Vacuumschmelze GmbH & Co. KG, Hanau (DE)

(72) Inventors: Niklas VOLBERS, Bruchköbel (DE); Rudi ANSMANN, Mombris (DE)

(21) Appl. No.: 17/031,363

(22) Filed: Sep. 24, 2020

(30) Foreign Application Priority Data
Sep. 25, 2019 (DE) 10 2019 125 862.6
Apr. 16, 2020 (EP) 20169961.8

(51) Int. Cl. H02K 1/14; H02K 1/02; H02K 15/02; H02K 3/18; C22C 38/10; C22C 30/00; C22C 38/12

(52) U.S. Cl. CPC H02K 1/148; H02K 1/02; H02K 15/022; C22C 38/12; C22C 38/105; C22C 30/00; H02K 3/18

(57) ABSTRACT

A multi-part stator for an electric machine is provided. The multi-part stator has a plurality of stator segments, each comprising a plurality of soft magnetic lamination sheets that are stacked one on top of another in a direction of stacking to form a laminated core. At least one lamination sheet projects on at least one edge side of the laminated core of a first stator segment and forms a finger. At least two lamination sheets project on at least one edge side of the laminated core of a second stator segment and form at least two fingers. The finger of the first stator segment and the at least two fingers of the second stator segment engage with one another in order to mechanically couple the first stator segment to the second stator segment.

This U.S. patent application claims priority to German patent application DE 10 2019 125 862.6, filed on Sep. 25, 2019, and European patent application EP 20169961.8, filed Apr. 16, 2020, the entire contents of which are incorporated herein by reference for all purposes.

### TECHNICAL FIELD

The invention relates to a multi-part stator, an electric machine and a method for producing a multi-part stator and an electric machine.

### RELATED ART

In most designs, electric machines comprise a stator made of a soft magnetic material. This stator may be made of a solid material. In some designs, the stator is made of single sheets or lamination sheets that are stacked one on top of another to form a so-called laminated core. The function of these sheets is to conduct magnetic flux in the sheet plane. High magnetic conductivity (permeability) of the material and the ability to carry the highest possible flux density (induction) are advantageous in that they increase the performance of the stator. The materials predominantly used for laminated cores for stators are made of silicon-iron (SiFe), i.e. Fe with the addition of 2 to 4 wt % (Si+Al). In applications in which maximum power density is required or desired, materials made of cobalt-iron (CoFe) are also used.

In addition to the choice of material, however, the manufacturing process used also influences the performance of the stator and so the entire electric machine. The individual sheets can be produced using various methods including, for example, stamping, laser cutting, water-jet cutting and electric discharge machining. The joining of the sheets to form the stator can be performed using a variety of methods including, for example, the application of a continuous laser weld seam or adhesive bonding. There are also methods in which sheets are added directly in the die, as with in-die stacking, for example.

A further method is the manufacture of individual stator teeth. They are manufactured to the desired height and then joined together to produce a complete stator. EP 0 833 427 A1, for example, discloses a method for the production of stator teeth.

When producing a stator from a plurality of stator teeth, the separate stator teeth must be aligned with one another and then joined together. To keep the air gaps between the parts small, this process must be carried out with precision in order to avoid or minimise loss of stator performance.

### SUMMARY

The object is therefore to provide a multi-part stator that is simpler and more reliable to assemble.

According to the invention, a multi-part stator is provided for an electric machine. The multi-part stator has a plurality of stator segments. The stator segments each have a plurality of soft magnetic lamination sheets that are stacked one on top of the other in a direction of stacking to form a laminated core. At least one lamination sheet projects on at least one edge side of the laminated core of a first stator segment and forms a finger. At least two lamination sheets project on at least one edge side of the laminated core of a second stator segment and form at least two fingers. The finger of the first stator segment and the at least two fingers of the second stator segment engage with one another in order to mechanically couple the first stator segment to the second stator segment.

Stator teeth and stator rings are both examples of stator segments. In one embodiment, a plurality of stator teeth are assembled to form a stator by means of their fingers. The stator teeth extend radially from an axis of rotation of the stator arranged at the centre of the stator such that the stator is cylindrical. The direction of stacking of the laminated core of stator segments is perpendicular to the main surface of the lamination sheet and thus parallel to the axis of rotation of the stator.

In one embodiment, these stator teeth are also surrounded by a stator ring that consists of one part and is mechanically coupled to the stator ring by the fingers.

The fingers are thus formed of at least one of the lamination sheets and in particular of an end part of the lamination sheets that projects from the edge side of the laminated core. The fingers of the two stator segments are interlocked with one another such that the finger of the first stator segment lies between the fingers of the second stator segment to form a joint. In the joint, the fingers of the two stator segments overlap and provide a mechanical connection between the two stator segments that is stable. As a result, further stator segments can gradually be added to the structure in the same manner without disrupting the orientation of the stator segments. The multi-part stator can thus be assembled more simply and using simpler tools. Only then can the assembled stator segments be fixed in place in order to complete the stator.

In addition, the interlocked fingers that overlap in the region of the joint mean that no continuous vertical air gap is formed and thus improve the magnetic properties of the stator.

In one embodiment, a recess is formed between the two fingers of the second stator segment and the finger of the first stator segment is arranged in the recess in the second stator segment in order to mechanically couple the first stator segment to the second stator segment. The recess is formed by the two adjacent fingers and the end face of at least one lamination sheet that is arranged between the two fingers.

In one embodiment, the fingers of the laminated core of the first stator segment are arranged alternately with the fingers of the laminated core of the second stator segment in the direction of stacking such that the finger or fingers of the first stator segment and the at least two fingers of the second stator segment engage with one another and common upper and lower sides of the stator are formed. The finger or fingers of the first stator segment thus face the recess between the fingers of the second stator segment, and the fingers of the second stator segment thus face the recess between the fingers of the first stator segment.

At least one edge side of a laminated core typically has a plurality of projecting fingers that are formed of at least one lamination sheet. The fingers are arranged one on top of the other in the direction of stacking and adjacent fingers are separated from one another by a recess.

In one embodiment, the fingers each comprise a single lamination sheet and the height of the recess between adjacent fingers corresponds to the thickness of one single lamination sheet.

This embodiment can be used for thicker lamination sheets that have sufficient inherent mechanically stability to provide a mechanical coupling.

In one embodiment, the fingers are each formed of a plurality of n lamination sheets, n being a natural number and n≥2. n non-projecting lamination sheets are arranged between adjacent fingers that form a recess of height h corresponding to the thickness of n lamination sheets.

This arrangement can be used for thinner lamination sheets to give the fingers greater mechanical strength in order to facilitate stator assembly.

In one embodiment, the fingers extend in a radial direction perpendicular to the direction of stacking, i.e. radially perpendicular from the axis of rotation of the stator. This arrangement can be used to joint the circumferential edge side of a stator tooth to a stator ring.

In one embodiment, the fingers extend in a circumferential direction. This arrangement can be used to join adjacent stator teeth to form a circular stator. This arrangement can also be used to join two or more arc-shaped parts of a stator ring together. These arc-shaped parts may each have one or more stator teeth.

In some embodiments, the stator segments have first fingers on a first edge side that extend in a radial direction, and second fingers on a second edge side that extend in a circumferential direction. This means that adjacent stator teeth can be joined to form a circular stator and joined to a stator ring.

In one embodiment, the width of the fingers is less than the width of the edge side of the laminated core. As a result, the fingers are arranged on only one part of the edge side of the stator segment. On the remaining edge sides, the end faces of the lamination sheets lie in a plane and form a planar edge side.

In some embodiments, the fingers each have an end face that itself has a cut-out or projection. The fingers of the first stator segment can each have a cut-out, and the recess in the second stator segment can have a projection, the cut-out and the projection engaging with one another in order to determine the lateral positions of the fingers and the recess and so the lateral positions of the first and second stator segments. Alternatively, the fingers of the first stator segment can each have a projection, and the recess in the second stator segment can have a cut-out, the cut-out and the projection engaging with one another in order to determine the lateral positions of the fingers and the recess. The cut-out may be U-shaped or V-shaped, for example, and the projection may be shaped like an inverted U or V.

As already mentioned above, the stator segments can provide various parts of the stator. For example, the stator segments can each take the form of a stator tooth, the stator teeth being joined together to form a cylindrical stator, or a stator segment can take the form of a stator ring and a plurality of stator segments can be shaped like a stator tooth, the stator teeth being joined together to form a cylindrical stator and being joined to an inner edge side of the stator ring.

In one embodiment, the stator segments each take the form of a part of a stator ring with a plurality of stator teeth, the parts of the stator ring being joined together to form a cylindrical stator. The fingers extend from the end face of the part of the stator ring, while the stator teeth are integral to the part of the stator ring. This arrangement means that there are fewer connecting points than in an arrangement in which each stator tooth is joined individually to a stator ring at a connecting point or in which each stator tooth is connected to two further stator teeth. A smaller number of connecting points may, for example, be used to improve the magnetic properties of the stator in order, for example, to reduce re-magnetisation losses.

The stator teeth may be T-shaped or I-shaped. The fingers may extend from the end face of the arms or horizontal parts of the T- or I-shape so as to provide a cavity between the edge sides of adjacent stator teeth of the stator or stator segment. A winding may be arranged in this cavity.

In one embodiment, the stator segments are stator teeth and the stator also has a winding for each stator tooth. This winding can be attached by means of linear winding, flyer winding, needle winding or by using a pull-in technique. The stator can be wound after assembly or the stator teeth can be wound individually and then assembled to form a stator.

In one embodiment, the laminated core has first and second lamination sheets that have the same surface area and the same outer contour. In this embodiment, the first lamination sheet and the second lamination sheet can be offset laterally in relation to one another in order to form an edge side with a finger formed by a projecting lamination sheet, e.g. the first lamination sheet, and a laterally opposite edge side with a finger formed by a projecting lamination sheet, e.g. the second lamination sheet. This embodiment can, for example, be used for rectangular lamination sheets.

In one embodiment, the laminated core has first lamination sheets and second lamination sheets that have different outer contours, the first and second lamination sheets each having a first end face and a second end face that is located opposite the first end face.

In one configuration, a first lamination sheet and a second lamination sheet are arranged such that a first end face of the first lamination sheet projects over a first end face of the second lamination sheet at a first edge side of the laminated core, and the second end face of the second lamination sheet projects over the second end face of the first lamination sheet on a second edge side of the laminated core located opposite the first edge side. This configuration can, for example, be used for stator teeth to be assembled to form a circular stator and so connected to a stator tooth on two opposite sides.

In a further configuration, a first lamination sheet and a second lamination sheet are arranged such that a first end face of the first lamination sheet projects over a first end face of the second lamination sheet on a first edge side of the laminated core, the second end face of the second lamination sheet and the second end face of the first lamination sheet being located in one plane on a second edge side of the laminated core. This embodiment can be used in a stator ring that is connected to the stator teeth on its inner edge side only. The second edge side may be opposite the first edge side or perpendicular to the first edge side.

In one embodiment, the length of the fingers of the laminated core of the first stator segment is at least 2 mm and the length of the recesses of the laminated core of the second stator segment is no less than the length of the fingers of the first laminated core. These dimensions permit easy handling during assembly and ensure sufficient mechanical stability until the assembly is joined together permanently.

The soft magnetic alloy of the lamination sheets may have a variety of compositions. For example, the lamination sheets may be made of an FeSi-based alloy comprising 2 to 4.5 wt % of at least one element from the group consisting of Si and Al, the rest Fe and unavoidable impurities.

In other embodiments, the soft magnetic alloy is a CoFe-based alloy. The CoFe-based alloy may comprise 35 to 55 wt % Co and up to 2.5 wt % V, the rest Fe and unavoidable impurities, or 45 wt %≤Co≤52 wt %, 45 wt %≤Fe≤52 wt %, 0.5 wt %≤V≤2.5 wt %, the rest Fe and unavoidable impurities, or 35 wt %≤Co≤55 wt %, preferably 45 wt %≤Co≤52 wt %, 0 wt %≤Ni≤0.5 wt %, 0.5 wt %≤V≤2.5 wt %, the rest Fe and unavoidable impurities, or 35 wt %≤Co≤55 wt %, 0 wt %≤V≤2.5 wt %, 0 wt %≤(Ta+2Nb)≤1 wt %, 0 wt %≤Zr≤1.5 wt %, 0 wt %≤Ni≤5 wt %, 0 wt %≤C≤0.5 wt %, 0 wt %≤Cr≤1 wt %, 0 wt %≤Mn≤1 wt %, 0 wt %≤Si≤1 wt %, 0 wt %≤Al≤1 wt %, 0 wt %≤B≤0.01 wt %, the rest Fe and unavoidable impurities, or 5 to 25 wt % Co, 0.3 to 5.0 wt % V, the rest Fe and unavoidable impurities.

Two or more different soft magnetic alloys may be used in one stator. For example, stator segments may be made of different alloys. In one embodiment, the stator teeth are made of one alloy and the stator ring is made of another alloy.

In some embodiments, the stator ring is made of a SiFe alloy and the stator teeth are made of a CoFe alloy. This combination can be used to reduce costs, in particular in applications that require less performance. With this combination of materials, some embodiments use stator teeth that have fingers that are wider than the length of the stator tooth in order to make the joint between the stator teeth and the stator ring wider and to reduce the magnetic resistance when the flux passes from the low-flux-carrying SiFe ring to the CoFe tooth.

It is also possible to make the laminated core of a stator segment out of lamination sheets made of different alloys. This embodiment can be used to adjust the magnetic properties of the laminated core.

An electric machine is also provided that comprises a rotor and a stator according to one of the embodiments described here and a winding around the stator. This electric machine is used as a motor or a generator.

A linear electric machine is also provided that comprises an armature and a rotor and a stator according to one of the embodiments described here and a winding around the stator. This linear electric machine is used as a motor or a generator.

The electric machine may, for example, serve as a drive for an electric or hybrid-electric aircraft, as a main or auxiliary drive for a motor vehicle or as a generator for producing power for an aircraft.

In one embodiment, a multi-part stator is provided for an electric machine that has a plurality of stator segments. The stator segments each have a plurality of soft magnetic lamination sheets that are stacked one on top of the other in a direction of stacking to form a laminated core. At least one lamination sheet projects on at least one edge side of the laminated core of a first stator segment and forms a finger. At least two lamination sheets project on at least one edge side of the laminated core of a second stator segment and form at least two fingers. The finger of the first stator segment and the at least two fingers of the second stator segment engage with one another in order to mechanically couple the first stator segment to the second stator segment. The first segment is arc-shaped and the fingers of the second stator segment extend perpendicular to the direction of stacking in a radial direction of the stator. The width of the fingers is less than or greater than or approximately the same as the width of the edge side of the second stator segment. The width of the fingers is also less than the width of the first segments.

In one embodiment, the first stator segment takes the form of a stator ring. A plurality of second stator segments are provided that each take the form of a stator tooth. The fingers of the stator teeth extend in a radial direction of the stator ring and are joined to an inner edge side of the stator ring to form a cylindrical stator.

According to the invention, a method is provided for producing a multi-part stator comprising the following:
providing at least one strip made of a soft magnetic alloy and coated with an insulating material,
forming a plurality of lamination sheets from the coated strip,
stacking a first plurality of lamination sheets one on top of another in a direction of stacking, the lamination sheets being arranged such that at least one lamination sheet projects on at least one edge and forms a finger,
connecting the lamination sheets and the formation of a first laminated core of a first stator segment having at least one finger on one edge side,
stacking a second plurality of lamination sheets (10, 11) one on top of another in a direction of stacking, the lamination sheets (10, 11) being arranged such that at least two lamination sheets project on at least one edge side and form at least two fingers (36),
connecting the lamination sheets and the formation of a second laminated core of a second stator segment having at least two fingers on one edge side,
joining the finger of the first stator segment and at least two fingers of the second stator segment such that the finger of the first stator segment and at least two fingers of the second stator segment engage with one another in order to mechanically couple the first stator segment to the second stator segment.

This method can be used to produce the multi-part stator according to one of the embodiments described here. Once the stator segments have been assembled, they are connected permanently together, e.g. bonded, fixed mechanically or soldered.

Materials made of silicon-iron (SiFe), i.e. Fe with the addition of 2 to 4 wt % (Si+Al) such as that commercially available under the trade name TRAFOPERM® N4 from Vacuumschmelze GmbH & Co KG of Hanau, Germany, can be used as the material for the lamination sheets. In applications in which the highest possible power density is required or desired, materials made of cobalt-iron (CoFe) are also used. Examples of such materials include VACODUR® 49 with an approximate composition of 49% Co, 49% Fe and 2% V and VACOFLUX® X1 with an approximate composition of 17% Co, 1.4% V and the rest iron. Both are also commercially available from Vacuumschmelze GmbH & Co KG of Hanau, Germany.

One advantage of this method is its lower production costs, which are achieved, firstly, because the stamping die required is considerably smaller and so less expensive and, secondly, because it produces less waste than producing a stator using a combination die. This advantage is very attractive for cost-intensive materials such as CoFe, but also for highly optimised SiFe materials with 2 to 4% Si such as the sheets with strip thicknesses of 0.10 mm and 0.20 mm known as NO10 and NO20.

The method according to the invention is very attractive for CoFe in particular since it is able to compensate for two material-specific disadvantages. Commercially available alloys comprising 49% Co, 49% Fe and 2% V are limited to strip widths of 340 mm, whereas SiFe alloys are available as standard in strip widths of over 1000 mm. As a result it is impossible to manufacture stators with an external diameter greater than 340 mm from a single piece of strip. On the other hand, methods using stator teeth make it possible to manufacture larger stators from CoFe. The larger the piece of strip, however, the more difficult it is to assemble the stator.

During the final magnetic annealing required after shaping, the aforementioned class of CoFe alloys exhibits growth in a range of 0.1% to 0.2%. With large parts, this means that the small tolerances required to ensure a small air gap between stator teeth and rotor, for example, can no longer be provided. However, if the same part is manufactured from individual teeth, absolute growth is smaller since each individual part is smaller. It is therefore easier to set small dimensional tolerances.

High-saturation soft magnetic materials with a Co content of up to 50% are particularly well suited to conducting magnetic flux through stator teeth. However, since Co is an expensive raw material and the process for manufacturing it typically complex every effort is made to restrict its use to a minimum. One approach to reducing the amount of expensive CoFe material used is to produce stator teeth using I-shaped CoFe and a stator ring made of a less expensive material such as SiFe. The CoFe teeth can then be mounted in the stator ring.

In the high-end machines sector it is also desirable to optimise copper windings in order to achieve high power density. In such applications individual teeth offer the advantage that the teeth can be wound first and then joined together to form a stator. With individually wound teeth it is possible to achieve higher copper densities, thereby permitting higher motor energisation at identical cooling capacity or, alternatively, requiring a lower cooling capacity at identical energisation.

In conventional configurations of individual teeth for the production of stators for electric motors the teeth are only aligned horizontally. They have no axial or vertical fixing. As a result, a complex assembly tool is generally required to fix the teeth in place once they have been joined together. Simply joining stator teeth in pairs provides insufficient inherent stability. These disadvantages are avoided in the configuration of the laminated core of the stator segments according to the invention.

In one embodiment for producing a stator segment, first lamination sheets with a first outer contour and second lamination sheets with a second outer contour that is different to the first outer contour are formed from the coated strip and stacked one on top of the other, once a first lamination sheet has been stacked on top of a second lamination sheet a finger being formed from a projecting part of the first lamination sheet or from a projecting part of the second lamination sheet.

In one embodiment, the first lamination sheets and second lamination sheets are stacked alternately one on top of the other. In this embodiment the fingers are formed from one single lamination sheet.

In one embodiment, n first lamination sheets are stacked one on top of the other and then n second lamination sheets are stacked in order to form a finger from n first lamination sheets or from n second lamination sheets, n being ≥2. This embodiment can be used to provide thicker fingers.

In one embodiment, the lamination sheets for the first stator segment are formed from a first strip of a first soft magnetic alloy and the lamination sheets for the second stator segment are formed from a second strip of a second soft magnetic alloy, the first and second soft magnetic alloys being different. This embodiment can, for example, be used to form stator teeth from a CoFe alloy and a stator ring from a FeSi alloy and to join them together to form a stator comprising two different materials.

In some embodiments, the lamination sheets of different stator segments are of different thicknesses. This may, for example, be the case if the stator segments have different compositions. In this case where the fingers and recesses of the segments to be joined are made of the same number of lamination sheets, they are of different thicknesses. It is possible to compensate for this difference in thickness so that the fingers are able to engage with one another by matching the numbers of first and second lamination sheets with different outer contours of the two stator segments to one another.

In one embodiment, n first lamination sheets are stacked one on top of the other for the first stator segment and m second lamination sheets are stacked on the n first lamination sheets, a finger being formed from a projecting part of the n first lamination sheets and/or from a projecting part of the m second lamination sheets. The number of m second lamination sheets represents a recess for the fingers of the second stator segment. The second stator segment is structured such that the recesses have a height h into which a finger of the first stator segment, comprising n lamination sheets, can be inserted, and so that a finger of the second stator segment an be inserted into the recess with a height h of m second lamination sheets of the first stator segment.

The plurality of lamination sheets can be formed by means of punching or laser cutting or water-jet cutting. The lamination sheets can be joined by means of laser welding or bonding.

In one embodiment, the laminated core is produced by means of in-die stacking. In in-die stacking the lamination sheets are formed, stacked and joined to the lamination sheets below them one after the other in the same in-die stacking tool.

Dependent on the composition of the soft magnetic alloy and the method used to produce the strip, one or more annealing processes can be carried out to adjust the joint and so the soft magnetic properties.

In one embodiment, the laminated core is annealed. In this embodiment, the stator segments are therefore annealed before being assembled to form the stator.

In one embodiment, the lamination sheets are annealed and then stacked to form a laminated core. The laminated core made of the annealed lamination sheets may also undergo a second annealing process.

In one embodiment, the stator segments are assembled to form a stator and the stator is then annealed.

The annealing conditions are set depending on the soft magnetic material selected.

For example, with a CoFe-based alloy comprising 35 to 55 wt % Co, up to 2.5 wt % V and the rest Fe and unavoidable impurities annealing for 6 h at 880° C. in dry hydrogen can be used.

With a CoFe-based alloy comprising 5 to 25 wt % Co, 0.3 to 5.0 wt % V and the rest Fe and unavoidable impurities annealing for 4 h at 1000° C. in dry hydrogen with slow cooling at 30 K/h to 900° C. can be used.

With a NiFe-based alloy annealing at between 1000° C. and 1200° C. in dry hydrogen, e.g. for 5 h at 1150° C., can be used.

With a FeSi-based alloy comprising 2 to 4.5 wt % of at least one element from the group consisting of Si and Al, the rest Fe and unavoidable impurities final annealing at typical temperatures of 850° C. to 1150° C. in dry hydrogen can be used.

In one embodiment, the stator segments, in particular stator segments in the form of a stator tooth, are wound with an electrically conductive wire and then assembled to form a stator. In other embodiments, the stator segments are first assembled to form a stator and the stator is then wound with an electrically conducting wire.

In one embodiment, the fingers of both stator segments extend in a radial direction perpendicular to the direction of stacking and the finger of the first stator segment and at least two fingers of the second stator segment are joined in a radial direction such that the finger of the first stator segment and at least two fingers of the second stator segment engage with one another and the first stator segment is mechanically coupled to the second stator segment.

In one embodiment, the fingers extend in a circumferential direction perpendicular to the direction of stacking and the finger of the first stator segment and at least two fingers of the second stator segment are joined in a circumferential direction such that the finger of the first stator segment and at least two fingers of the second stator segment engage with one another and the first stator segment is mechanically coupled to the second stator segment.

The width of the fingers may be less than the width of the edge side such that parts of the edge side of the first laminated core that have no finger are located at a distance from an adjacent edge side of a second laminated core, while the fingers overlap and form a joint.

In some embodiments, the fingers of the first stator segment each have a cut-out and the recess in the second stator segment has a projection, the cut-out and the projection being joined together in order to determine the lateral positions of the fingers and the recess and to determine the reciprocal lateral alignment of the first and second stator segments. In particular, the end faces of the lamination sheets that form the fingers and recesses each have a cut-out or a projection in order to form the cut-outs of the corresponding fingers and the projections of the corresponding recesses.

Alternatively, the fingers of the first stator segment can each have a projection and the recess in the second stator segment can have a cut-out, the cut-out and the projection being joined together in order to determine the lateral positions of the finger and the recess and to determine the mutual alignment of the first and second stator segments.

The stator segments can each take the form of a stator tooth, the stator teeth being joined together to form a cylindrical stator, or a stator segment can take the form of a stator ring and a plurality of stator segments can each take the form of a stator tooth, the stator teeth being joined together to form a cylindrical stator and being joined to an inner edge side of the stator ring.

In a further embodiment, the stator segments each take the form of a part of a stator ring comprising a plurality of stator teeth, the parts of the stator ring being joined together to form a cylindrical stator. In this embodiment, every lamination sheet has an arc-shaped part of the stator ring and a plurality of integral projecting parts that form the stator teeth.

Various embodiments will now be explained in greater detail with reference to the attached drawings and the examples.

### BRIEF DESCRIPTION OF THE DRAWINGS

FIG. 1 shows a schematic view of an electric machine having a stator and a rotor.

FIG. 2 shows a top view (left and right) of two different individual sheets and, in the centre, of two different sheets, one lying on top of the other, for a stator according to the invention.

FIG. 3a shows a side view of the individual teeth of the stator according to the invention.

FIG. 3b shows a side view of the interlocked individual teeth of a stator according to the invention.

FIG. 3c shows a schematic representation of the course of flux in the joint shown in FIG. 3b.

FIG. 4 shows a stator ring according to the invention having a stator tooth configured according to the invention that can be inserted into the stator ring.

FIG. 5 shows a schematic sequence for the manufacture of a stator from individual teeth.

FIG. 6 shows a schematic sequence of various processes for manufacturing an individual tooth from a coated strip.

FIG. 7 shows an embodiment of differently configured sheets that are stacked alternately.

FIG. 8 shows an embodiment of differently configured sheets that are stacked alternately, a plurality of sheets of the same shape lying on top of one another.

FIG. 9 shows a representation of the stator ring-stator tooth joining system with alternately configured sheets prior to joining.

FIG. 10 shows a representation of the stator ring-stator tooth joining system with alternately configured as per FIG. 9 after joining.

FIG. 11 shows a representation of an edge side of a stator segment according to a further embodiment.

FIG. 12 shows a top view of two stator segments, each having a plurality of stator teeth.

FIG. 13 shows a perspective view of the stator segments shown in FIG. 12.

FIG. 14 shows a further perspective view of the stator segments shown in FIG. 12.

FIG. 15a shows a perspective view of a stator tooth according to one embodiment.

FIG. 15b shows a perspective view of a stator tooth according to a further embodiment.

FIG. 15c shows a perspective view of a stator tooth according to a further embodiment.

FIG. 16a shows a perspective view of a stator ring-stator tooth joining system with alternately configured sheets prior to joining.

FIG. 16b shows a perspective view of a stator ring-stator tooth joining system with alternately configured sheets prior to joining.

### DETAILED DESCRIPTION OF EXAMPLE EMBODIMENTS

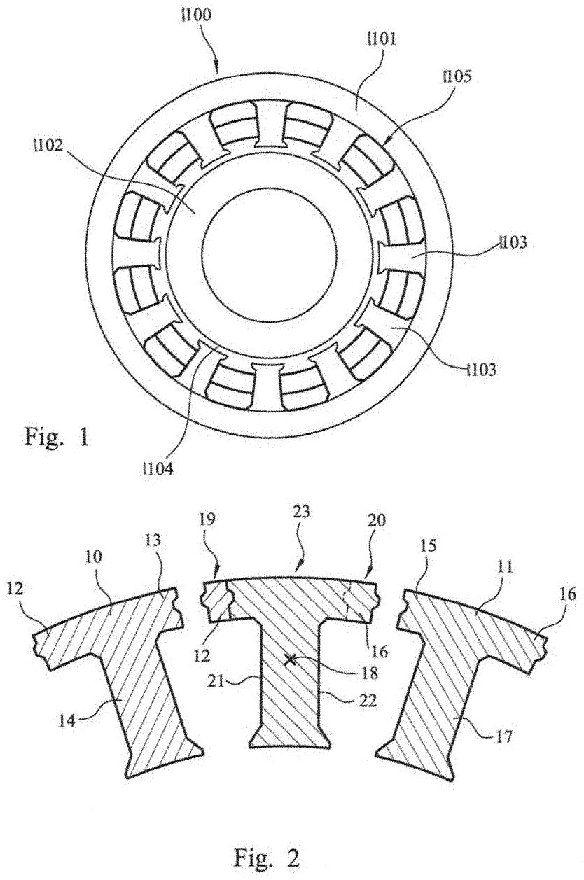

FIG. 1 shows a schematic view of an exemplary electric motor 1100 having a stator 1101 made of a soft magnetic alloy and a rotor 1102. The rotor 1102 is surrounded and separated from the stator 1101 by an air gap 1104. The stator 1101 is assembled from a plurality of stator segments 1103, the radial segments 1103 conventionally being referred to as teeth. The teeth 1103 are evenly distributed and wound with coils 1105. The rotor 1102 usually has a plurality of permanent magnets that rotate past opposing electromagnetically excitable poles of the stator 1101 separated by an air gap. In this arrangement, the electromagnetically excitable poles take the form of stator teeth made of a soft magnetic material, for example, around the tooth core of which a coil winding induces a magnetic field during energisation. The torque is transmitted to the rotor 1102 by the clocked energisation of the stator teeth 1103 or their coil windings 1105.

Joining the separate segments 1103 of the stator 1101 creates an additional air gap between the segments. When in use, an air gap of this type leads to a reduction in magnetic conductivity (permeability) in the magnetic circuit. This in turn requires higher currents in the coil in order to achieve the necessary flux density. In order to reduce the amount by which the soils heat up as a result, it is in turn necessary to increase the cross section of the coil. This is, firstly, not always possible and, secondly, always associated with additional costs.

The invention relates to the production of stator segments from laminated cores that have at least one edge side with projecting parts and to the production of a multi-part stator from these stator segments.

The segments can be fixed in place by means of these projecting parts of the laminated cores. These projecting parts are formed by the outer contours of the lamination sheets. Owing to their design, the stator segments according to the invention offer the following advantages:
a continuous air gap is avoided,
the pressure required during fitting is low, thereby reducing stresses in the material, and
once joined together the segments have an inherent stability and any assembly tool can therefore be significantly simpler or dispensed with altogether.

Stator segments that can be interlocked are produced by placing individual sheets with different shapes on top of one another. This produces a connection that fixes the segments in place. In magnetic terms, the avoidance of continuous air gaps is advantageous.

The laminations or individual sheets can be produced by means of stamping or laser cutting. The stacking of the laminations or individual sheets to form a laminated core can be achieved by means of bonding, welding or in-die stacking.

The stator comes in various designs so that it can be used in various designs of electric machine. The method can also be used in the production of stators for linear motors, i.e. the stator need not necessarily be round in shape.

FIG. 2 shows a top view of two different lamination sheets 10, 11 (left and right), each in the shape of a T. In the centre it shows two different lamination sheets 10, 11 lying one on top of the other.

The first lamination sheet 10 has a longer arm 12 on the left-hand side of the horizontal part than the arm 13 on the right-hand side of the vertical column 14. The second lamination sheet 11 has a shorter arm 15 on the right-hand side of the horizontal part than the arm 16 on the left-hand side of the vertical column 17.

When the second lamination sheet 11 is stacked on the first lamination sheet 10, as shown in the centre of FIG. 2, the direction of stacking 18 is perpendicular to the main surface of the lamination sheets 10, 11 and perpendicular to the drawing planes.

The vertical columns 14, 17 have the same outer contour so that when they are stacked directly one on top of the other the left-hand arm 12 of the first lamination sheet 10 projects over the left-hand arm 15 of the second lamination sheet 11 and forms a finger 19. The right-hand arm 16 of the second lamination sheet 11 projects over the right-hand arm 13 of the first lamination sheet 10 beneath it such that this projecting part also forms a finger 20.

Stacking the lamination sheets 10, 11 alternately one on top of another produces a laminated core 23 with projecting fingers 19, 20 that are arranged on opposing edge sides 21, 22 of the laminated core 23 and in different planes in the direction of stacking 19. The lamination sheets 10, 11 can be stacked to form a laminated core 23 of a stator tooth.

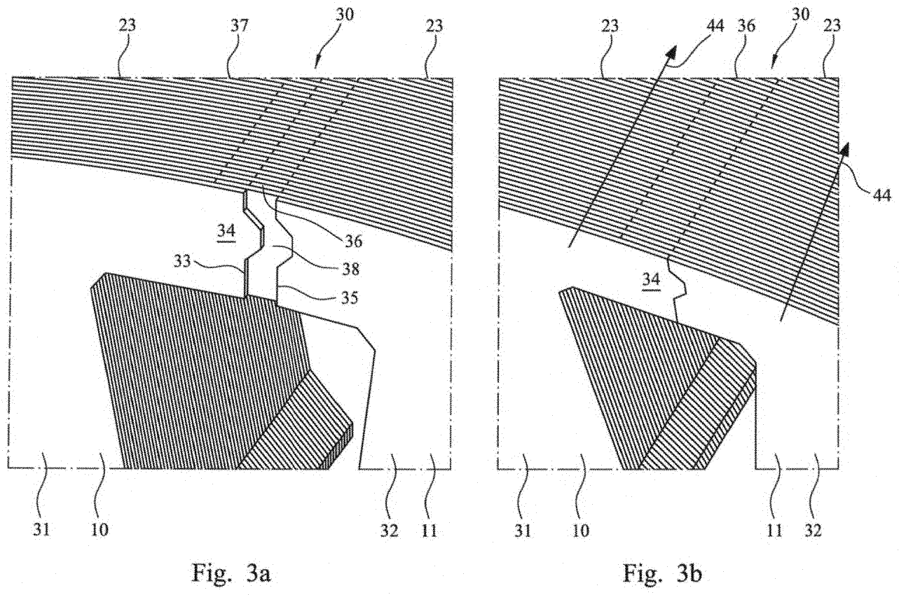

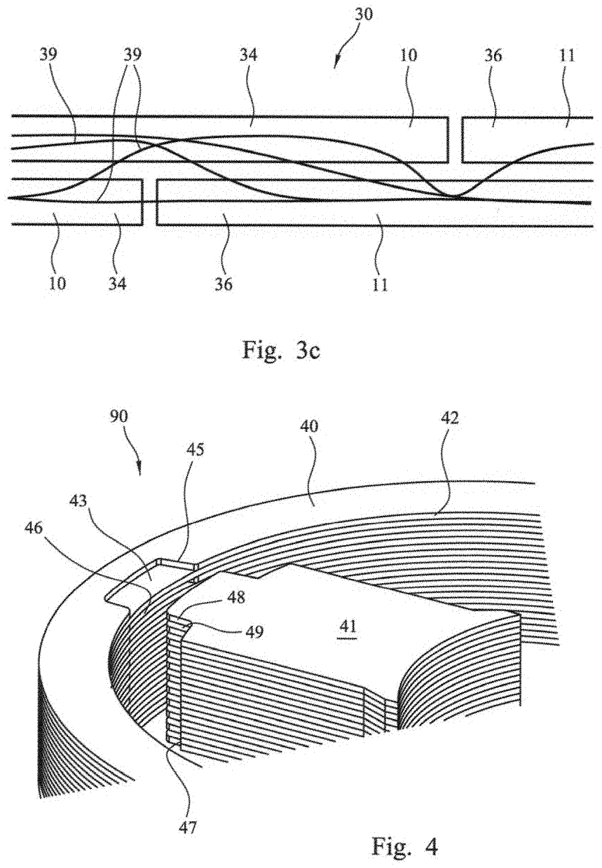

FIGS. 3a and 3b show side views of the joint 30 with two interlocked individual teeth 31, 32, each consisting of a laminated core with a direction of stacking 44. The laminated core be the laminated core 23 made from lamination sheets 10, 11 as shown in FIG. 2.

The edge side 33 of the first stator tooth 31 has a plurality of fingers 34 that are formed by lamination sheets of the laminated core of the first stator tooth 31. The edge side 35 of the second stator tooth 32 also has a plurality of fingers 36 that are formed by lamination sheets of the laminated core of the second stator tooth 31. A recess 37 is formed between adjacent fingers 34 of the first stator tooth 30 and a recess 38 is formed between the adjacent fingers 34 of the second stator tooth 31.

In FIG. 3a the fingers 34, 36 point towards one another and in the representation in FIG. 3b the fingers 34, 36 engage with one another in order to mechanically couple the stator teeth 31, 32 together. The fingers 34 of the first stator tooth 30 are thus arranged in the recess 38 of the second stator tooth 31 and the fingers 36 of the second stator tooth 31 are arranged in the recess 37 of the first stator tooth 30. The interlocking of the fingers 34, 36 forms a joint 30 between the stator teeth 31, 32 in which the fingers 34, 36 overlap.

FIG. 3c shows a schematic representation of the course of flux 39 in the joint 30 shown in FIG. 3b. The magnetic flux also moves in the sheet plane and perpendicular to the direction of stacking 44 between a lamination sheet 10 of the stator tooth 31 and a lamination sheet 11 of the stator tooth 32. The air gap between the lamination sheet 10 of the stator tooth 31 and the lamination sheet 11 of the stator tooth 32 can be circumvented if the flux 39 instead shifts sheet plane and runs on the adjacent lamination sheet 34 until, for example, it finally returns to the original sheet plane after the transition between the lamination sheet 10 of the stator tooth 31 and the lamination sheet 11 of the stator tooth 32, as shown schematically in FIG. 3c. This path is magnetically advantageous because the surface of the sheet is available for the shift to the adjacent sheet plane, but only the significantly smaller cross section at the transition is available for the shift to the adjacent sheet in the same sheet plane.

FIG. 4 shows a view of a stator ring 40 and a stator tooth 41 of a stator that are each formed from a laminated core. The stator ring 40 is a circular ring and has an inner edge side 42 that is shaped in one region so as to form fingers 43 that extend in the direction of the centre of the stator ring 40. The fingers 43 are formed by a portion of the lamination sheet. In this embodiment, every second lamination sheet is provided with a cut-out 45 on the inner edge side that lies in a recess 46 between the two adjacent fingers 43, i.e. the top and bottom fingers 43. The fingers 43 are formed from lamination sheets without cut-outs and form the circular inner edge side 42 of the stator ring 40.

The stator tooth 41 has an edge side 47 with projecting fingers 48 that have a width, a depth and a vertical arrangement that allow them to interlock with the fingers 43 of the stator ring in order to mechanically couple the stator tooth 41 with the stator ring 40. The fingers 48 are each formed of a lamination sheet of the laminated core of the stator tooth 41, and a recess 49 is formed by the end face of the lamination sheet of the laminated core of the stator tooth arranged between two adjacent fingers 48. Once the two parts have been joined, the fingers 43 of the stator ring 40 are arranged in the recesses 49 in the stator tooth 41 and the fingers 48 of the stator tooth 41 are arranged in the recesses 46 in the stator ring 40.

The width of the stator tooth 41 is greater than the width of the fingers 48 and recesses 46. Outside of the finger 48, the edge side 47 has a rounded contour that corresponds to the circular contour of the inner edge side 42 of the stator ring 40.

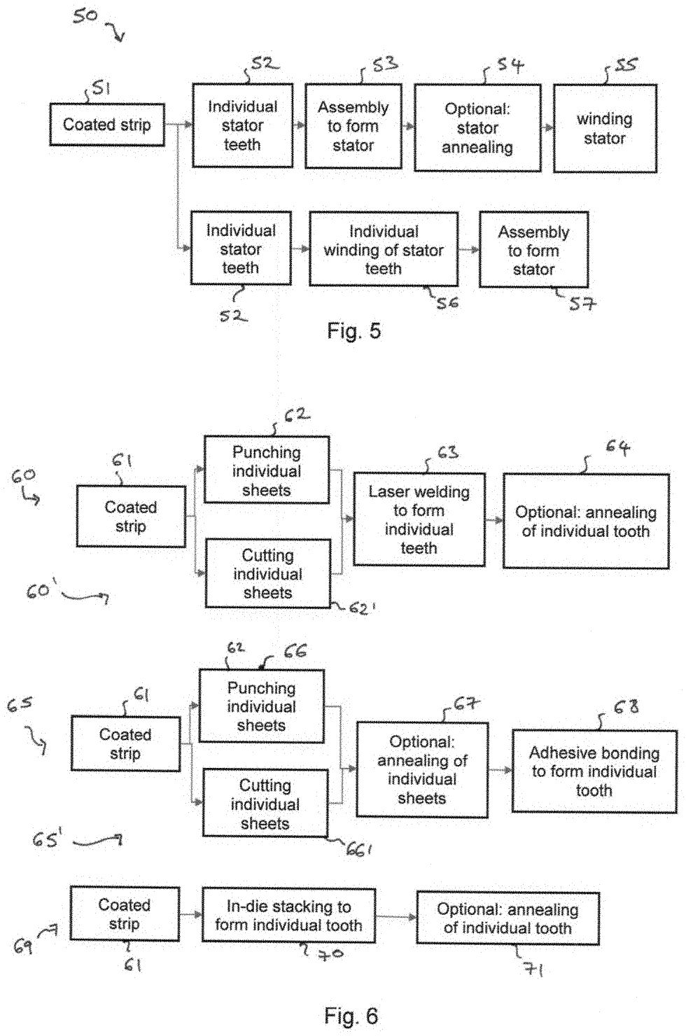

FIG. 5 shows a flow chart 50 for the manufacture of a stator from individual teeth. In box 51 a strip made of a soft magnetic alloy and coated in an insulating layer is provided. In box 52 individual stator teeth are formed from the strip and stacked and fixed in place to form a laminated core. In box 53 the individual stator teeth are assembled to form a stator. In box 54 optional final magnetic annealing is carried out and, finally, the stator is wound in box 55. In the alternative process, after box 52 the individual teeth are wound individually before assembly in box 56 and assembled to form a stator in box 57. In the alternative method the stator does not undergo final annealing. If final annealing is really necessary it is carried out on the individual teeth, i.e. after box 52.

FIG. 6 shows a flow chart for various process for manufacturing an individual tooth from a coated strip. The soft magnetic alloy strip is coated with an insulating material and the individual sheets or laminations are then formed from the coated strip, stacked and joined together in order to produce a laminated core with the desired outer contour.

In one embodiment 60, the coated strip in provided in box 61 and the single sheets are punched from the strip and joined by laser welding to form a laminated core in box 62. The stamping tool has different dies. In a subsequent step 63 the punched individual sheets are joined to form individual teeth by welding. The individual teeth thus produced can be annealed individually in box 64 and then joined together. Alternatively, or in addition, the assembled stator can also be annealed.

In an alternative embodiment 60′, the individual sheets are cut out of the strip and joined by laser welding to form a laminated core in box 62′. Individual sheets of difference shapes are produced by laser welding or water jet cutting. In a subsequent step 63, the individual cut sheets are joined to form individual teeth by welding. The individual teeth thus obtained can be annealed individually in box 64 and then joined together to form a stator.

In one embodiment 65, the individual sheets are stamped from the strip and joined together by bonding to form a laminated core in box 66. The stamping tool has different dies. The stamped individual sheets are then annealed in box 67. Following annealing, the individual sheets are bonded together to form an individual tooth in box 68. The individual bonded teeth are then joined together to form a stator.

In an alternative embodiment 65′, the individual sheets are cut from the strip and joined together by means of bonding to form a laminated core in box 66′. individual sheets of different shapes are produced by laser cutting or water jet cutting in box 66′. The individual cut sheets are then annealed in box 67. Following annealing, the individual sheets are bonded together to form an individual tooth in box 68. The individual bonded teeth are then joined together to form a stator.

In one embodiment 69 in-die stacking is used in box 70. The different shapes of the individual sheets are produced by controllable tools in the die. The individual teeth are joined by means of punching studs in the die. The individual teeth thus obtained can be individually annealed in box 71 and then joined together. Alternatively or in addition, the assembled stator can also be annealed.

In a further embodiment, the individual sheets are first annealed so that they can subsequently be welded. However, the annealing of single sheets is more complex and there is also the risk that the application of the weld seam following final annealing may impair soft magnetic properties.

To simplify the joining together of the stator segments, the fingers can project at least 2 mm, thereby creating an overlap for fixing. To ensure that the individual teeth can be inserted easily the surface roughness of the material should not be too high. With thin sheets it can be advantageous to stack a plurality of sheets of the same type one on top of the other to make them easier to joint together.

It is also possible to use soft magnetic materials employed in other manufacturing processes, such as:
cobalt-iron alloys (CoFe) comprising 49% Co, 49% Fe, 2% V, e.g. VACODUR® 49.
cobalt-iron alloys (CoFe) comprising 17% Co, 1.4% V and the rest Fe, e.g. VACOFLUX® X1.
Nickel-iron alloys (NiFe) comprising 40 to 50% Ni, e.g. PERMENORM® 5000 V5, MEGAPERM 40® L and ULTRAVAC 44® V6.
Silicon-iron alloys (SiFe) comprising 2 to 4% (Si+Al) and the rest Fe, e.g. TRAFOPERM®® N4. Non-grain-oriented (NGO) SiFe is used for motors.

Depending on the soft magnetic material chosen, magnetic final annealing is used to adjust the soft magnetic properties, e.g.:
CoFe: with VACODUR® 49 annealing for 6 h at 880° C. in dry hydrogen.
CoFe: with VACOFLUX® X1 annealing in dry hydrogen for 4 h at 1000° C. with slow cooling at 30 K/h to 900° C.
NiFe: with MEGAPERM 40® L, PERMENORM® 5000 V5 and MEGAPERM 50 L annealing at between 1000° C. and 1200° C., typically for 5 h at 1150° C. in dry hydrogen.
“Semi-processed” SiFe: final annealing at typical temperatures of 850° C. to 1150° C. in dry hydrogen. TRAFOPERM® N4: 5 h at 1150° C.
“Fully finished” SiFe: final annealing has already been carried out by the manufacturer in the factory and is not therefore required.

The strip has an annealing-resistant coating to prepare it for annealing. The following coatings can be used:
With CoFe an inorganic coating is used. After annealing it is present as MgO or ZrO.
With NiFe an inorganic coating is used due to the high annealing temperatures. After annealing it is present as MgO or ZrO, preferably ZrO.
With SiFe non-annealing-resistant bonding varnishes are often used. Annealing-resistant coatings with a certain inorganic percentage do exist.

### EMBODIMENTS

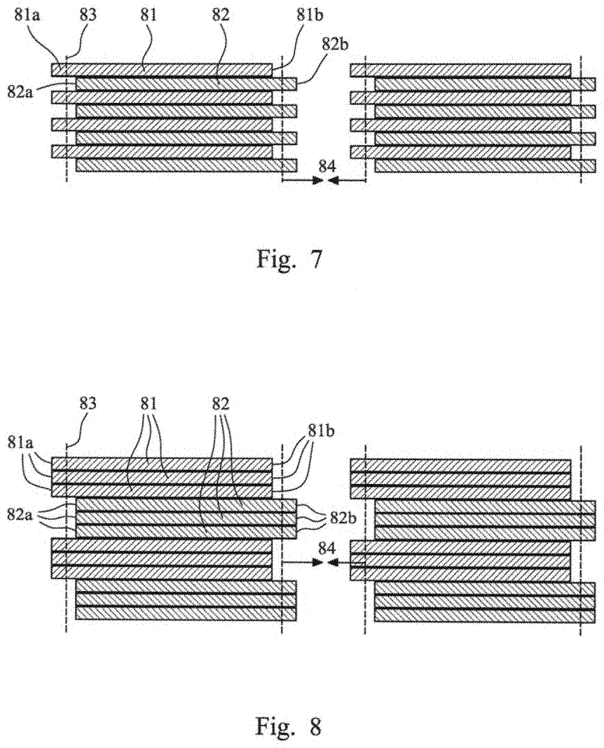

In one embodiment, the stator teeth are punched in a T-shape from the coated strip in a progressive tool. To this end, the tool has two different dies that produce two different sheet shapes 81, 82, as shown in FIGS. 7 and 8.

These sheet shapes 81, 82 have the following differences. The first sheet type 81 has a longer side 81a on the left-hand side of the T-segment and a shorter side on the right-hand side of the T-segment 81b. In each case, the side is longer or shorter than a notional starting line 83 by an identical amount. The second sheet type 82 is mirror symmetrical in terms of the joining system, i.e. the right-hand side of the T-segment 82b is the longer side and the left-hand side of the T-segment 82a is the shorter side. Here too, the sides are longer or shorter than the notional starting line 83 by an identical amount.

FIG. 7 shows an embodiment of a laminated core in which the first sheet type 81 and the second sheet type 82 are stacked alternately. As a result, each layer of the laminated core has a projecting part or finger, the projecting parts of adjacent layers extending in opposite directions.

FIG. 8 shows an embodiment in which a plurality of sheets of the same shape lie one on top of the other. In this embodiment, in order to simplify assembly, the number of joints is reduced by stacking a plurality of sheets of one type 81, 82 one on top of the other such that each finger is formed by a plurality of sheets of one type. If the strip thickness is 0.20 mm the sheets are stacked in threes, as shown in FIG. 8. In a further example, five of each type of sheet are used. If the strip thickness is even smaller, e.g. 0.10 mm, 10 of each type of sheet are used.

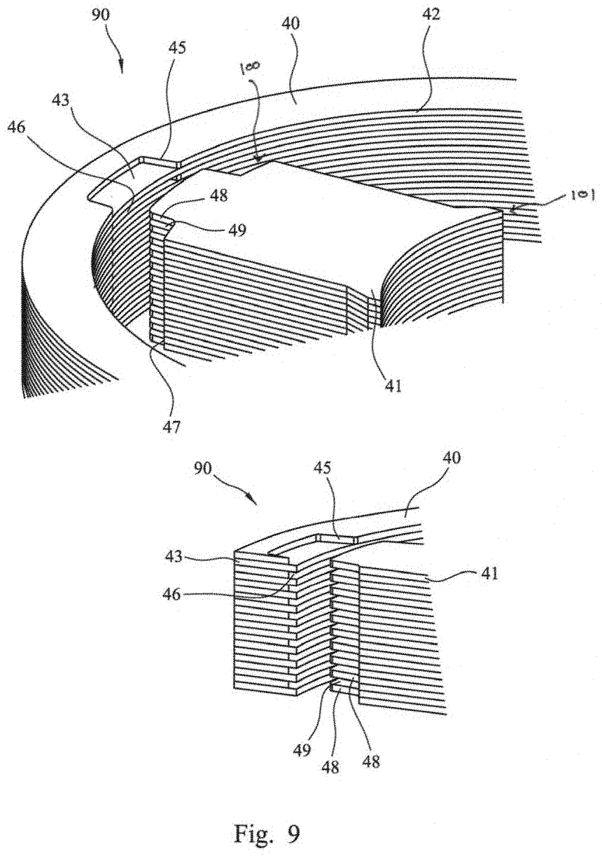

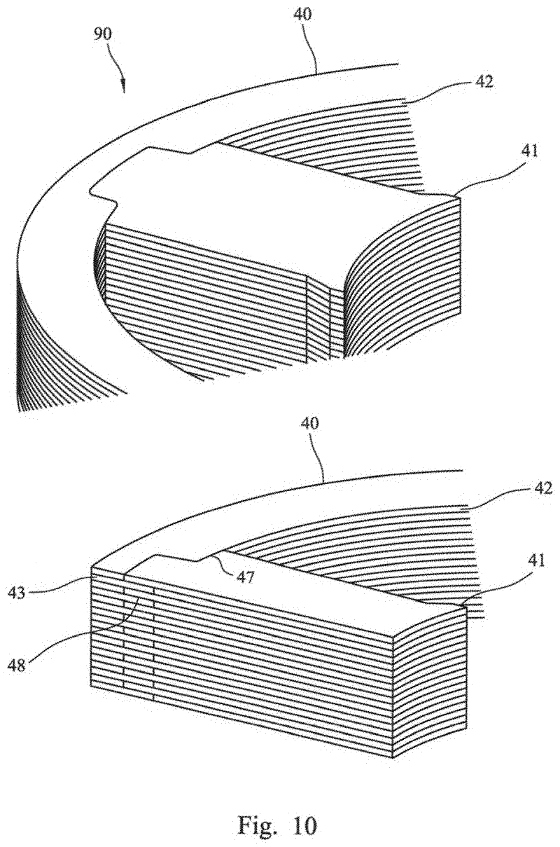

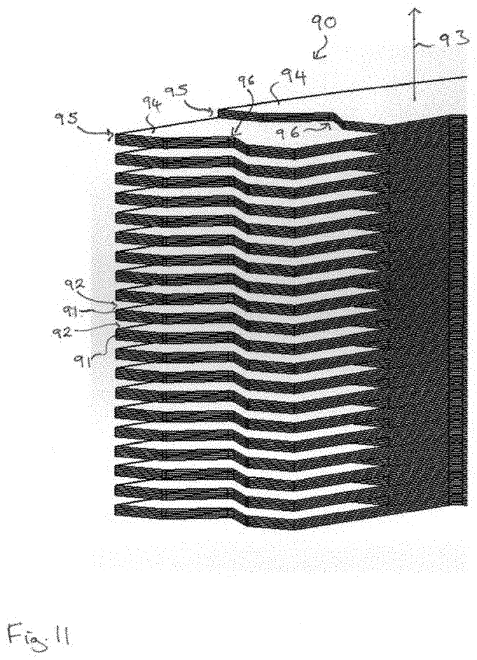

FIG. 9 shows an enlarged representation of the stator ring-stator tooth joining system 90, the stator ring 40 and stator tooth 41 both having their pre-joining shapes, as shown in FIG. 4. FIG. 10 shows a representation of the stator ring-stator tooth joining system 90 as per FIG. 9 after joining. FIG. 10 shows that the fingers 48 of the stator tooth 41 are arranged in the recesses 46 in the stator ring 40 such that the lamination sheets form a common layer of the stator. The fingers 43 of the stator ring 40 are also arranged in the recesses 49 in the stator tooth 41 such that the lamination sheets form a common layer of the stator. The overlap between the fingers 43, 48 of the two segments 40, 41 is shown by the broken lines in FIG. 10.

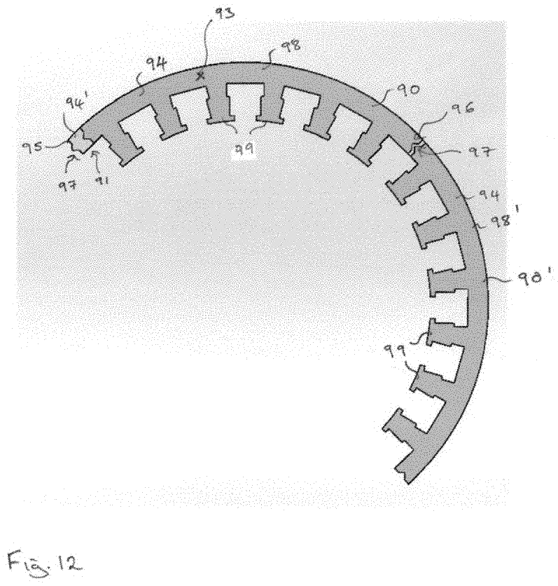

FIG. 11 shows a representation of an edge side of a stator segment 90 having projecting fingers 91 such that a recess 92 is formed between adjacent fingers 91 in a direction of stacking 93. In this embodiment, both the fingers 91 and the recesses 92 are formed of four lamination sheets 94. However, both the fingers 91 and the recesses 92 may comprise any number of lamination sheets in order to provide a desired finger 91 or recess 22 thickness.

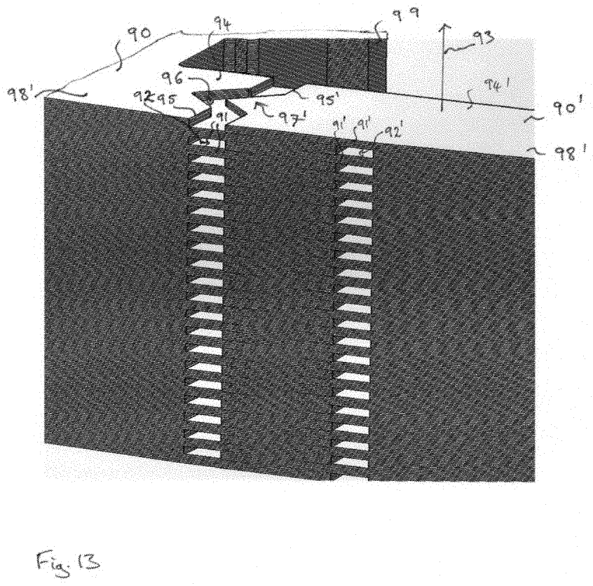

The lamination sheets 94 have an end contour 95 with a cut-out 96 that is joined to a projection 97 of a lamination sheet 94′ of an adjacent stator segment 90′, as shown in FIGS. 12 to 14. As a result, the lateral arrangement of the fingers 91 and recesses 92 and of the two stator segments 90, 90′ can be determined by the mechanical coupling of the cut-out 96 to the projection 97 of lamination sheets 94, 94′, in this context the term “lateral” referring to the arrangement in directions at right angles to the direction of stacking 93. In some embodiments, the cut-out 96 and the projection 97 have a round, e.g. a semi-circular shape, or a U-shape or a rectangular or square shape. In the embodiment shown in FIG. 11, the cut-out 97 has a pointed or V-shape.

FIG. 12 shows a top view of the stator segment 90, which indicates clearly that the lamination sheets 94 of the stator segment 90 each have an outer contour that provides an arc-shaped part 98 of a stator ring with an arc length and a plurality of parts arranged perpendicular to the arc length that form the stator teeth 99. The stator teeth 99 lie in the same plane of the lamination sheet 94 as the arc-shaped part 98. The stator teeth 99 of the stator segment 90 are integral to the arc-shaped part 98. The part 98 is arc shaped, the stator teeth 99 extending from the inside or shorter side of the part 98. A plurality of parts 98 can be joined together in order to form a circular stator ring, the stator teeth 99 being arranged regularly around the inside of the stator ring and extending in the direction of the centre of the circular stator ring.

Similar to the embodiment shown in FIG. 2, the opposing end faces of the lamination sheet 94 of the arc-shaped part 98 have a cut-out 96 or a projection 97 to form the recesses 92 or fingers 91 of the edge sides of the stator segment 90. Similar to the embodiment shown in FIG. 2, FIG. 12 shows two lamination sheet shapes 94, 94′, the first lamination sheet 94′ having a longer left arm and a shorter right arm, and the second lamination sheet 94 having a shorter left arm and a longer right arm such that when the two lamination sheets 94, 94′ are stacked one on top of the other in the direction of stacking 93 to form the stator segment, as shown in FIG. 12, the fingers 91 are formed on opposing edge sides of the part 98 and in different planes and extend in opposing directions in the circumferential direction. The stator teeth 99 of the two lamination sheets 94, 94′ each have the same outer contour and are stacked one on top of the other such that the edge sides of the stator teeth 99 and the inside and outside of the part 98 of the stator ring form a planar surface and have no fingers or recesses.

A plurality of stator segments 90, 90′ are provided, two of which are shown in FIG. 12. The plurality of stator segments 90, 90′ each have a part 98 of a stator ring with a plurality of integral stator teeth 99 and are joined together to form a closed, e.g. circular, stator ring and the stator. These stator segments 90, 90′ may have the same or different arc lengths and so the same or different number of stator teeth 99.

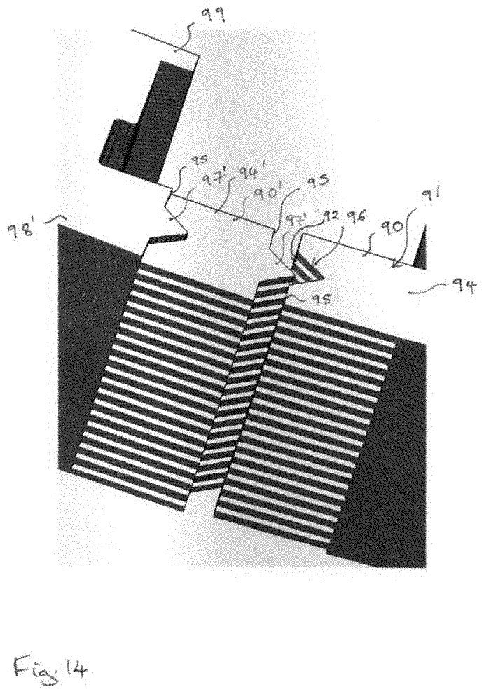

As also shown in the perspective views in FIGS. 13 and 14, the fingers 91 of adjacent edge sides of the parts 98, 98′ of the stator ring are interlocked such that the fingers 91 of a stator segment 90 are arranged between the fingers 91′ of the adjacent stator segment 90′ and in the recesses 92′ in the second stator segment 90′. The V-shaped projections 97′ of the first stator segment 90′ are arranged in the V-shaped cut-out 96 of the adjacent stator segment 90 in order to determine the reciprocal lateral alignment of the stator segments 90, 90′.

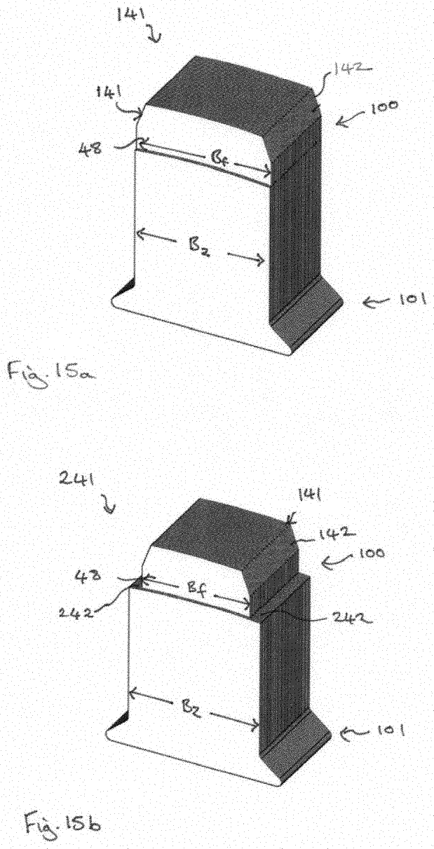

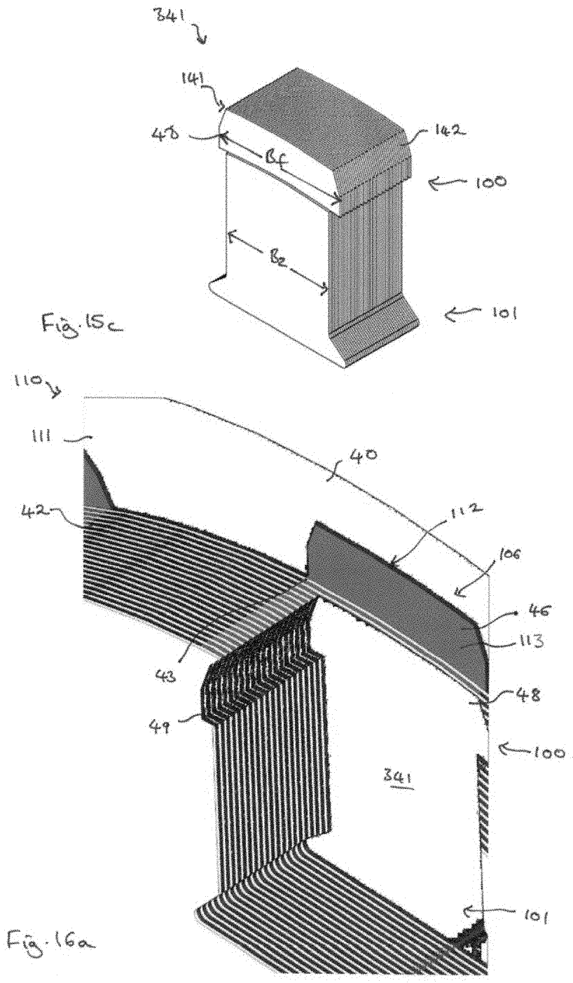

A stator segment in the shape of an individual stator tooth may have different outer contours. FIGS. 15a to 15c show three embodiments in which the ratios between the width B_{f} of the fingers and the width B_{z} of the tooth are different. The individual teeth have a first end 100 that features the finger 48 and an opposing end 101 that points towards the stator axis when assembled.

FIG. 15a shows a perspective view of an individual stator tooth 141 according to an embodiment in which the width B_{f} of the finger 48 is approximately the same as the width B_{f} of the adjacent region of the stator tooth 141. The end 141 of the finger 48 has rounded or bevelled corners 142. This shape of the end 141 can be used to make it easier to insert the finger 48 into the recesses 46 in the stator ring 40.

FIG. 15b shows a perspective view of an individual stator tooth 241 according to a further embodiment in which the width B_{f} of the finger 48 is less than the width B_{z} of the adjacent region of the stator tooth 241. A shoulder 242 is thus formed on two opposing sides of the stator tooth 41. When assembled, this shoulder 242 abuts the inner side wall 42 of the stator ring 40. The end of the finger 48 has rounded or bevelled corners 142.

FIG. 15c shows a perspective view of a stator tooth 341 according to a further embodiment in which the width B_{f} of the finger 48 is greater than the width B_{z} of the adjacent region of the stator tooth 341 such that the finger 48 forms a head. The end of the finger 48 has rounded or bevelled corners 142. This shape of stator tooth 341 can be referred to as an I-shape as the two opposing ends 100, 101 are wider than the central region of the stator tooth 341.

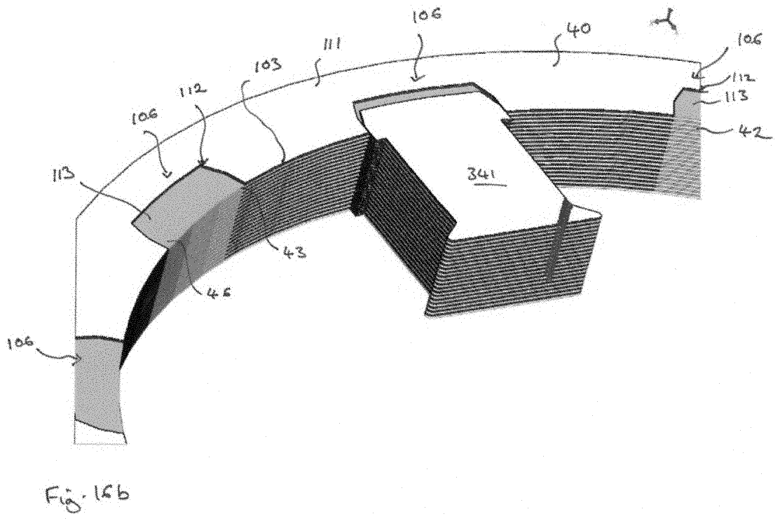

FIGS. 16a and 16b show perspective views of a stator ring-stator tooth joining system 110 comprising a stator ring 40 and a plurality of individual stator teeth that can be inserted into the inner edge side 42 of the stator ring 40 in order to form a cylindrical stator by virtue of the fact that the individual teeth extend in a radial direction 104 in relation to the axis 105 of the stator. FIGS. 16a and 16b show a perspective view of a stator ring-stator tooth joining system 110 with alternately configured lamination sheets 111 prior to joining. The stator tooth 341 illustrated has the outer contour shown in FIG. 15c.

FIG. 16b shows the positions of a plurality of points 106 on the inner edge side 42 of the stator ring 40 each designed to receive an individual tooth 341. Formed in lamination sheets 111 that alternate at regular intervals along the inner edge side 42 are cut-outs 112 that correspond to the outer contour of the fingers 48 of the individual teeth 341. No cut-outs are formed on the lamination sheets 113 of the stator ring 40 arranged between them and these regions thus form the fingers 43 on the inner edge side 42 of the stator ring 40 while the cut-outs 112 form the recesses 46 in the stator ring 40.

The stator ring 40 may be made of a different alloy to the stator teeth 341. For example, the stator ring 40 may be made of SiFe sheets while the stator teeth 341 are made of a CoFe alloy.

This combination can be used to reduce costs, particularly in applications that require less power. In this case, the embodiment shown in FIG. 15c can be used to make the link between the stator teeth 341 and the stator ring 40 wider and to reduce the magnetic resistance at the transition of the flux from the low-flux-carrying SiFe ring to the CoFe teeth.

### Embodiment 1

In the first embodiment, stator teeth are produced using a CoFe alloy. VACODUR® 49 comprising 49% Co, 49% Fe, 1.9% V and 0.1% Nb is used as the primary material. A strip of the alloy is produced is follows: melting in a vacuum, blooming, hot rolling to 2 mm, quenching in a salt water bath at above 730° C., cold rolling to a final thickness of 0.20 mm, where appropriate trimming or cutting to final width.

Optionally, additional continuous annealing in a dry H₂ atmosphere can be carried out at final thickness, i.e. brief heating of the strip to a temperature of at least 700° C. and rapid cooling at a cooling rate of at least 1000 K/h. This step serves to anticipate part of the adjustment in order and so to partially anticipate the length growth that takes place during the subsequent final annealing of the material. To better set the joint a further stationary annealing process in a dry H₂ atmosphere at temperatures of at least 650° C. can also be carried out prior to continuous annealing.

At final thickness, the thus strip obtained is coated with a magnesium methylate solution that is partially transformed into magnesium hydroxide by a drying process at approx. 200° C. Further calcination takes place during the subsequent final annealing process and on the finished annealed band the coating is therefore present predominantly as magnesium oxide. This coating both serves as electrical insulation to minimise eddy current losses in the stator and prevents the strip layers from fusing together during subsequent final annealing.

In one embodiment, two different T-shaped sheet forms for the stator teeth are punched from the coated strip and stacked, as shown in FIGS. 7 and 8, for example, so that opposing edge sides of the stator teeth have projecting fingers and the fingers of adjacent stator teeth engage with one another in order to join the stator teeth.

The individual sheets are then joined by means of laser welding. Here the number of laser weld seams is chosen according to the shape so as to ensure a sufficiently strong joint along the entire height.

In a variant, the T-shaped stator teeth are produced by means of in-die stacking. Here the contour is stamped out and the individual layers are joined by studs in the die. Using controllable tools in the die it is possible to produce the different contours and number of layers required and so to determine the height of the teeth. This manufacturing process is particularly well suited to larger volumes.

Finally, the stator teeth undergo further final magnetic annealing. This takes place in a bell-type furnace in a dry hydrogen atmosphere, for example. Here the saturation temperature is below −30° C., preferably below −50° C., to ensure that no oxides are formed on the CoFe material during annealing. In this example, the selected annealing temperature is 6 h at 880° C. in order to guarantee re-crystallisation with subsequent grain growth and so to set the desired soft magnetic properties such as low coercive field strength and high permeability.

In a further example, this annealing of the stator teeth can also take place in a continuous furnace, it then being necessary to adjust temperature and time according to furnace length and speed as appropriate.

The annealed stator teeth are then individually wound using a linear winding technique or a flyer winding technique, for example.

The individual annealed and wound stator teeth are then assembled by interlocking them as shown schematically in FIGS. 7 and 8 by the arrows 84. This interlocking operates in a manner similar to a tongue and groove system, the tongues and grooves being formed by the alternating lengths of sheets placed one on top of the other. This system makes it very easy to insert one into the other.

The finished stator can be aligned precisely by means of an assembly tool such as a cable tie or hose clip, for example, that is fixed around the stator over its full height. By tightening the tie or clip appropriately it is possible to set the external diameter to the desired dimension.

In a further embodiment, rather than being annealed individually the stator teeth are interlocked prior to annealing. If necessary, the finished stator can then be aligned more precisely using an assembly tool. The complete stator comprising the individual interlocked teeth then undergoes final magnetic annealing. This is carried out under the conditions already described above for the stator teeth. The finished, annealed stator is then provided with the necessary windings.

### Embodiment 2

To produce teeth from SiFe including final annealing, non-finally annealed, non-grain-oriented electrical strip steel is used as the primary material. In this embodiment, TRAFOPERM® N4 (VAC) with a strip thickness of 0.20 mm is used. This material has the composition Fe 2.4% Si 0.35% Al and additions of up to 0.2% Mn for deoxidisation. After shaping, the material must undergo a further magnetic final annealing process.

The strip is coated with a magnesium methylate solvent at final thickness as in the first embodiment. This coating is resistant up to approx. 1050° C. Alternatively, a ZrO coating applied in the form of zirconium propylate can be used. After final annealing it is present as bonded zirconium oxide. This coating has the advantage of high temperature resistance which means that the coating remains in place at annealing temperatures of up to 1150° C.

Stamping or in-die stacking can be carried out as described in the first embodiment, as can the various annealing options (annealing of individual stator teeth or annealing of the entire stator core). For stationary annealing, 5 h at 1150° C. in a dry hydrogen atmosphere is chosen for the material in order to achieve the lowest coercive field strength and so low hysteresis losses in the material. In a further example, annealing for a period of 5 h at a temperature of 850° C. results in higher inductions.

It is important to maintain a low saturation temperature of <−30° C. in order to avoid the formation of a layer of silicon oxide or aluminium oxide due to the Si and Al content of the alloy. Such layers exhibit high surface roughness and thus hamper and even prevent the interlocking of the sheets.

### Embodiment 3

In order to produce stator teeth from fully-finished SiFe sheets, pre-annealed iron silicon is used as the primary material. This state is referred to as “fully-finished”. One example is the electric steel strip quality N020-1200H (Cogent Power) with a strip thickness of 0.20 mm. Owing to its composition, this material features Fe comprising 3-5% (Si+Al) and a high electric resistance of more than 0.50 μΩm. In combination with the small strip thickness, this results in very low re-magnetisation losses, making the material very well suited to applications with high electric frequencies.

In one example, the strip is provided with an inorganic coating (available under the trade name SURALAC® 7000 from Cogent Power) applied by the manufacturer that has a typical thickness of less than one μm. T-shaped sheets are then punched from the strip by the process described above for CoFe. The individual sheets are joined to form teeth either by in-die stacking during the punching process or, alternatively, following punching by laser welding.

In a further example, the strip is provided with an epoxy-based organic coating by the manufacturer (SURALAC® 9000), also referred to as bonding varnish. The T-shaped stator teeth are then punched out of the strip in a die. The die has different tools able to produce differently shaped sheets for this purpose.

The sheets are then stacked and joined to one another in a special heat treatment process under pressure at increased temperature using the bonding varnish coating. In this process the coating is first fused, allowing the coatings on adjacent sheets to bond with one another. When the temperature is increased somewhat the bonding varnish cures, resulting in a stator tooth made of laminations that are permanently fixed together. The exact temperatures and pressure for the process depend on the bonding varnish used.

The baked stator teeth are then individually wound, using a linear winding technique or a flyer winding technique, for example. The teeth are then assembled to form the stator.

These embodiments can be used to produce other stator components or segments, a stator component being a stator tooth or a stator ring or a part of a stator ring comprising a plurality of stator teeth, for example. Different components can be formed from different materials and with a variety of further processing steps.

### Embodiment 4

In order to produce stator teeth (I-segments) from CoFe and a stator ring from SiFe, the primary material used for the stator ring is iron silicon, e.g. ZrO-coated TRAFOPERM N4 with a strip thickness of 0.20 mm, as used in the third embodiment. Stator rings are punched out of the SiFe strip in a die using a combined tool, two different sheet types being manufactured alternately by means of controllable tools. The first sheet type (A) takes the form of a continuous ring. The second sheet type (B) is a ring with identical external and internal diameters in which rectangular or trapezoidal notches are provided in the internal diameter. Stacking these sheets alternately, in the sequence ABAB . . . or AABBAABB . . . , for example, produces notches into which the stator teeth can subsequently be inserted.

The sheets for the stator ring can be stacked in die, for example, or alternatively joined outside the die by means of laser welding. In both cases the entire finished stator ring then undergoes final magnetic annealing, e.g. stationary annealing for 5 h at 1150° C. in a dry hydrogen atmosphere.

VACOFLUX, a CoFe alloy with 49% Co, 49% Fe and 1.9% V, 48 is used as the primary material for the I-shaped stator teeth. The use of CoFe is logical for this part since it makes to possible to conduct a higher magnetic flux through the stator teeth.

The thickness of the strip for the stator teeth is the same as that of the primary material for the stator ring. They both also have an annealing-resistant coating, though not necessarily the same one. In this example, as in the first embodiment, a magnesium methylate-based solvent is used.

The stator teeth are then punched in a die, it once again being possible to manufacture two different sheet types alternately by means of controllable tools. The two sheet types (A) and (B) differ in that sheet type (B) has an additional surface that is coextensive with the rectangular or trapezoidal notch in the stator ring sheet (B). The A sheets for the stator ring and stator tooth thus represent a matching pair, as do the B sheets.

In this example, after punching the sheets for the stator teeth are stacked one on top of the other in the same sequence as for the stator ring, i.e. for example in the sequence ABAB . . . or the sequence AABBAABB . . . . The sheets are then joined together, for example by one or more laser welding seams. The stator teeth joined in this manner then undergo heat treatment in order to adjust the magnetic properties, e.g. for 10 h at 880° C. in dry hydrogen.

In a further example, the stacked sheets are bonded together to form stator teeth using a capillary adhesive that gets between the intermediate layers to ensure good adhesion of the sheets. In this case, any heat treatment must be carried out in advance on the punched sheets.

The finished stator teeth are then assembled in the stator ring simply by interlocking them. The entire stator is then wound. In a further example, the stator teeth are first wound individually and the wound stator teeth are then inserted into the stator ring during assembly.

1. A multi-part stator for an electric machine, comprising a plurality of stator segments,
the stator segments each having a plurality of soft magnetic lamination sheets that are stacked one on top of another in a direction of stacking to form a laminated core,
at least one lamination sheet projecting on at least one edge side of the laminated core of a first stator segment and forming a finger, and at least two lamination sheets projecting on at least one edge side of the laminated core of a second stator segment and forming at least two fingers,
the finger of the first stator segment and the at least two fingers of the second stator segment engaging with one another in order to mechanically couple the first stator segment to the second stator segment.

2. A stator according to claim 1, wherein
a recess is formed between the two fingers of the second stator segment, and the finger of the first stator segment is arranged in the recess in the second stator segment in order to mechanically couple the first stator segment to the second stator segment.

3. A stator according to claim 1, wherein
the fingers extend perpendicular to the direction of stacking in a radial direction of the stator.

4. A stator according to claim 1, wherein
the fingers extend in a circumferential direction of the stator.

5. A stator according to claim 4, wherein
the fingers each have an end face with a cut-out or a projection.

6. A stator according to claim 1, wherein
a width of the fingers is less than or greater than or approximately the same as a width of the edge side.

7. A stator according to claim 2, wherein
the fingers of the first stator segment each have a cut-out, and the recess in the second stator segment has a projection, the cut-out and the projection engage with one another in order to determine the lateral positions of the fingers and the recess, or
the fingers of the first stator segment each have a projection, and the recess in the second stator segment has a cut-out, the cut-out and the projection engage with one another in order to determine the lateral positions of the fingers and the recess.

8. A stator according to claim 7, wherein
the stator segments each have the form of a stator tooth, these stator teeth being joined to form a cylindrical stator.

9. A stator according to claim 1, wherein
one stator segment has the form of a stator ring and a plurality of stator segments each have the form of a stator tooth and the stator teeth are joined to an inner edge side of the stator ring and form a cylindrical stator.

10. A stator according to claim 1, wherein
the stator segments each have the form of a part of a stator ring comprising a plurality of stator teeth and the parts of the stator ring being joined to one another to form a cylindrical stator.

11. A stator according to claim 1, wherein
the lamination sheets is made of an FeSi-based alloy comprising 2 to 4.5 wt % of at least one element from the group consisting of Si and Al and the rest Fe and unavoidable impurities.

12. A stator according to claim 1, wherein
the lamination sheets is made of an alloy made of the group consisting of
a CoFe-based alloy comprising 35 to 55 wt % Co and up to 2.5 wt % V, the rest Fe and unavoidable impurities,
a CoFe-based alloy comprising 45 wt %≤Co≤52 wt %, 45 wt %≤Fe≤52 wt %, 0.5 wt %≤V≤2.5 wt %, the rest Fe and unavoidable impurities,
a CoFe-based alloy comprising 35 wt %≤Co≤55 wt %, preferably 45 wt %≤Co≤52 wt %, 0 wt %≤Ni≤0.5 wt %, 0.5 wt %≤V≤2.5 wt %, the rest Fe and unavoidable impurities,
a CoFe-based alloy comprising 35 wt %≤Co≤55 wt %, 0 wt %≤V≤2.5 wt %, 0 wt %≤(Ta+2Nb)≤1 wt %, 0 wt %≤Zr≤1.5 wt %, 0 wt %≤Ni≤5 wt %, 0 wt %≤C≤0.5 wt %, 0 wt %≤Cr≤1 wt %, 0 wt %≤Mn≤1 wt %, 0 wt %≤Si≤1 wt %, 0 wt %≤Al≤1 wt %, 0 wt %≤B≤0.01 wt %, the rest Fe and unavoidable impurities, and
a CoFe-based alloy comprising 5 to 25 wt % Co, 0.3 to 5.0 wt % V, the rest Fe and unavoidable impurities.

13. An electric machine, comprising:
a rotor,
a stator according to claim 1 and
a coil in the space between the stator teeth around the stator or around the stator teeth.

14. A method for producing a multi-part stator, comprising:
providing at least one strip made of a soft magnetic alloy and coated with an insulating material,
forming a plurality of lamination sheets from the coated strip,
stacking a first plurality of lamination sheets one on top of another in a direction of stacking, the lamination sheets being arranged such that at least one lamination sheet projects on at least one edge side and forms a finger,
connecting the lamination sheets and the formation of a first laminated core of a first stator segment having at least one finger on one edge side,
stacking a second plurality of lamination sheets one on top of another in a direction of stacking, the lamination sheets being arranged such that at least two lamination sheets project on at least one edge side and form at least two fingers,
connecting the lamination sheets and the formation of a second laminated core of a second stator segment having at least two fingers on one edge side,
joining the finger of the first stator segment and at least two fingers of the second stator segment such that the finger of the first stator segment and at least two fingers of the second stator segment engage with one another in order to mechanically couple the first stator segment to the second stator segment.

15. A method according to claim 13, wherein
first lamination sheets with a first outer contour and second lamination sheets with a second outer contour different to the first outer contour are formed from the coated strip and stacked one on top of another, and after the stacking of a first lamination sheet on a second lamination sheet a finger is formed from a projecting part of the first lamination sheet or the second lamination sheet.

16. A method according to claim 14, wherein
the lamination sheets of the first plurality are formed from a first strip of a first soft magnetic alloy and the lamination sheets of the second plurality are formed from a second strip of a second soft magnetic alloy, the first and second soft magnetic alloys being different.

17. A method according to claim 13, wherein
the fingers extend perpendicular to the direction of stacking in a radial direction and the finger of the first stator segment and at least two fingers of the second stator segment are joined in a radial direction such that the finger of the first stator segment and at least two fingers of the second stator segment engage with one another and the first stator segment is mechanically coupled to the second stator segment.

18. A method according to claim 17, wherein
the fingers extend perpendicular to the direction of stacking in a circumferential direction and the finger of the first stator segment and at least two fingers of the second stator segment are joined in a circumferential direction such that the finger of the first stator segment and at least two fingers of the second stator segment engage with one another and the first stator segment is mechanically coupled to the second stator segment.

19. A multi-part stator for an electric machine comprising a plurality of stator segments,
the stator segments each comprising a plurality of soft magnetic lamination sheets that are stacked one on top of the other in a direction of stacking to form a laminated core,
at least one lamination sheet projecting on at least one edge side of the laminated core of a first stator segment and forming a finger, and at least two lamination sheets projecting on at least one edge side of the laminated core of a second stator segment and forming at least two fingers,
the first segment being arc-shaped and the fingers of the second stator segment extending in a radial direction of the stator perpendicular to the direction of stacking and having a width that is less than or greater than or approximately equal to the width of the edge side of the second stator segment and less than the width of the first segment.

20. A stator according to claim 19, wherein
the first stator segment has the form of a stator ring and a plurality of second stator segments are provided that each have the form of a stator tooth, the fingers of the stator teeth extending in a radial direction of the stator ring and being joined to an inner edge side of the stator ring in order to form a cylindrical stator.
